(19) United States
(12) Patent Application Publication
(10) Pub. No.: US 2010/0297315 A1
(43) Pub. Date: Nov. 25, 2010

(54) Sushi making apparatus

(76) Inventors: Ouriel Ouaknine, Lery (CA); Marc Ouaknine, Lery (CA)

Correspondence Address: Ouriel Ouaknine, 3591, Gouin E. #106, Montreal, QC, H1H 5V7, CA

(21) Appl. No.: 12/766,897

(22) Filed: Apr. 25, 2010

(30) Foreign Application Priority Data
May 21, 2009 (GB) 0908804.8

(51) Int. Cl. A21C 9/04; A23P 1/10

(52) U.S. Cl. 426/297; 425/427

(57) ABSTRACT

A sushi making apparatus has a board, a sushi receptacles, a mat, a plurality of frames. The board has a three sided perimeter which has sharp edges; the fourth side of the perimeter is made with one of the frames.

### FIELD OF THE INVENTION

The present invention relates generally to food preparation devices but more particularly to the preparation of maki, also known as sushi.

### BACKGROUND OF THE INVENTION

Sushi is a very popular delicacy but sometimes, a lot of sushi has to be prepared quickly and the tools being used right now are not adequate for making perfectly and consistently made sushi at a fast pace. Moreover, there are no practical and efficient tools to help make it easier for people to make sushi at home.

### SUMMARY OF THE INVENTION

In view of the foregoing disadvantages inherent in the known devices now present in the prior art, the present invention, which will be described subsequently in greater detail, is to provide objects and advantages which are:

To provide for an easy and convenient way of producing high quality sushi quickly.

Another advantage of this invention is to make it easier for people to make sushi at home.

To attain these ends, the present invention generally comprises a board member having first, second, and third side perimeter members forming a three sided perimeter on a top surface thereof. The board member and three sided perimeter formed and adapted to receive and hold a quantity of rice and other sushi ingredients, an elongated cradle portion adjacent an edge of the board member that does not include a side of the three sided perimeter. A mat member adapted to be placed upon the top surface of the board member and in between the three sided perimeter, the mat member including an axle and a pair of handles on opposite ends of the axle, the axle and handles being located on one edge of the mat member and are adapted to be placed within the cradle portion of the board member. At least one frame member adapted and sized to fit upon the top surface of the board member along and adjacent the edge of the board member that includes the cradle member, having a width equal to a distance between the first and third sides of the three sided perimeter, having a predetermined length thereby forming an inner volume in conjunction with the three sides of the three sided perimeter, and having a height equal to the three sides of the three sided perimeter; a rolling pin having a length that is longer than the distance between the first and third sides of the three sided perimeter and adapted to roll along the top edges of the three sided perimeter, and is used to spread and flatten the rice within the square area; and a sushi receptacle placed adjacent the edge of the board member that is adjacent the middle side of the three sided perimeter, the sushi receptacle is adapted to receive the rice and other sushi ingredients when rolled and pushed therein by the mat member.

The mat member further includes a T-shaped edge along an edge opposite the edge that includes the axle and handles wherein the mat member is formed from a flexible material, and is adapted to roll up the rice and other sushi ingredients into a cylinder shape when the axle and handles are rolled along the length of the first and second perimeter members and toward the sushi receptacle.

The board member further includes a slit along a side thereof adjacent the second perimeter member, the slit being adapted to receive and hold the T-shaped edge of the mat member.

At east one frame member includes at least one hook member adapted to releasably attach to the board member.

The board member further includes at least one notch adapted to receive and releasably hold the at least one hook member of the at least one frame member.

A plurality of frame members having differing lengths, wherein one of the plurality of frame members is chosen and used for its desired length, which then correlates to the desired inner volume and amount of rice and other sushi ingredients therein.

The sushi receptacle further includes at least one tenon member adapted to releasably attach to the board member.

The sushi receptacle includes a plurality of slits therein adapted to receive a cutting instrument therethrough for cutting the rice and other sushi ingredients into a desired number of sections.

The three side perimeter members of the three sided perimeter are formed as elongated strips having a sharp top edge along their lengths.

A spatula member having a length that is longer than the distance between the first and third sides of the three sided perimeter, the spatula being adapted to slide along the top edges of the three sided perimeter and grade off and remove rice and other sushi ingredients that do not fit within the inner volume.

The invention is a method of making sushi comprising the steps of:

a. placing a mat member over a board member;

b. placing a frame member on top of the board member;

c. placing a quantity of rice on top of the mat member and filling the volume defined by the board member and the frame member;

d. spreading and flattening the rice within the volume by using a rolling pin;

e. placing a sheet of algae over the rice;

f. removing the frame;

g. adding other sushi ingredients on top of the rice:

h. rolling the mat member until the rice and other sushi ingredients are firmly and neatly rolled into a sushi roll.

A method of making sushi comprising the steps of providing a board member having first, second, and third side perimeter members forming a three sided perimeter on a top surface thereof, the board member and three sided perimeter formed and adapted to receive and hold a quantity of rice and other sushi ingredients, an elongated cradle portion adjacent an edge of the board member that does not include a side of the three sided perimeter; a mat member adapted to be placed upon the top surface of the board member and in between the three sided perimeter, the mat member including an axle and a pair of handles on opposite ends of the axle, the axle and handles being located on one edge of the mat member and are adapted to be placed within the cradle portion of the board member; at least one frame member adapted and sized to fit upon the top surface of the board member along and adjacent the edge of the board member that includes the cradle member, having a width equal to a distance between the first and third sides of the three sided perimeter, having a predetermined length thereby forming an inner volume in conjunction with the three sides of the three sided perimeter, and having a height equal to the three sides of the three sided perimeter; a rolling pin having a length that is longer than the distance between the first and third sides of the three sided perimeter and adapted to roll along the top edges of the three sided perimeter, and is used to spread and flatten the rice within the square area; and a sushi receptacle placed adjacent the edge of the board member that is adjacent the middle side of the three sided perimeter, wherein the frame member is placed on top of the board member; the mat member is placed within the area defined by the frame member; a quantity of rice is placed on top of the mat member filling the volume defined by the board member and the frame member; the rice is spread and flattened within the volume by using the rolling pin; placing a sheet of algae over the rice; removing the frame; rolling the mat member until the rice and other sushi ingredients are firmly and neatly rolled into the sushi receptacle as one long sushi roll; cutting the sushi roll into a desired number of smaller sushi rolls.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Perspective view of the invention.

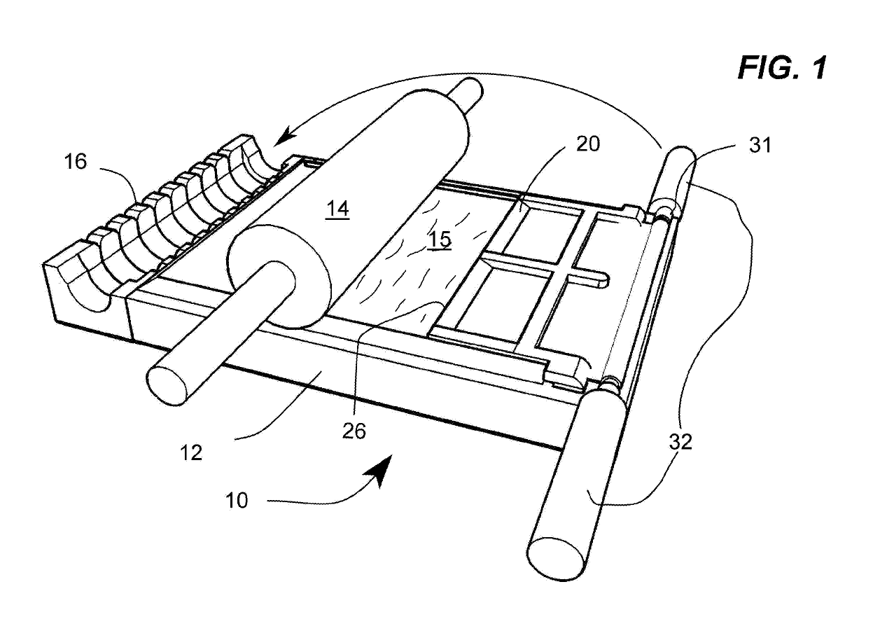

FIG. 2 Perspective view of the board.

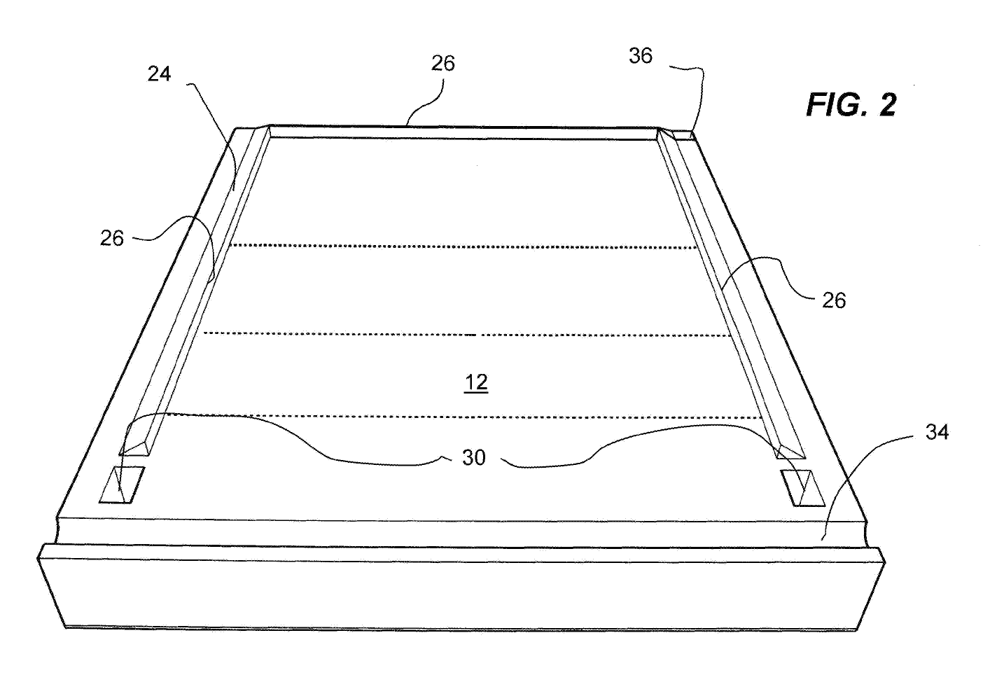

FIG. 3 Perspective view of the components seen separately.

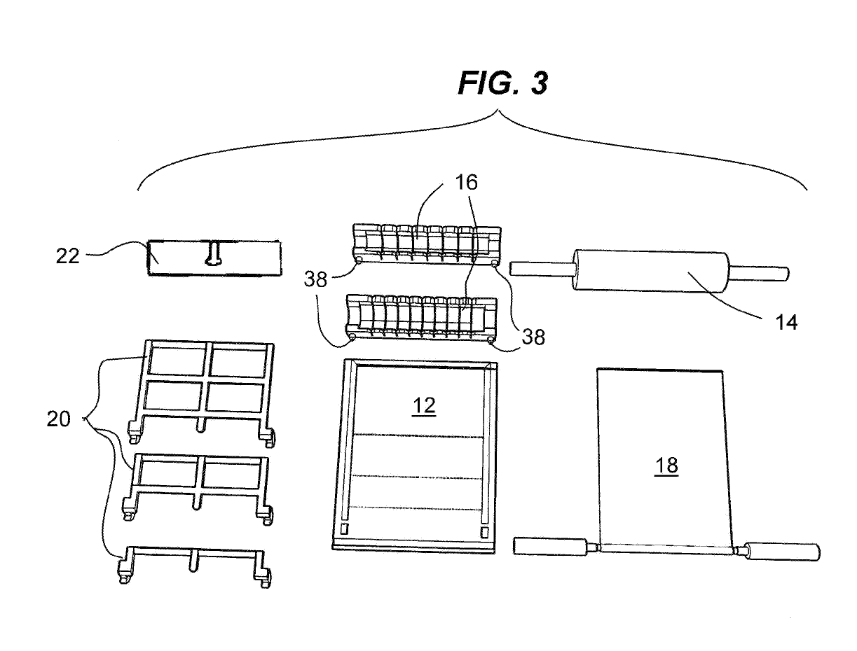

FIG. 4 Perspective view of the mat featuring the “T” end.

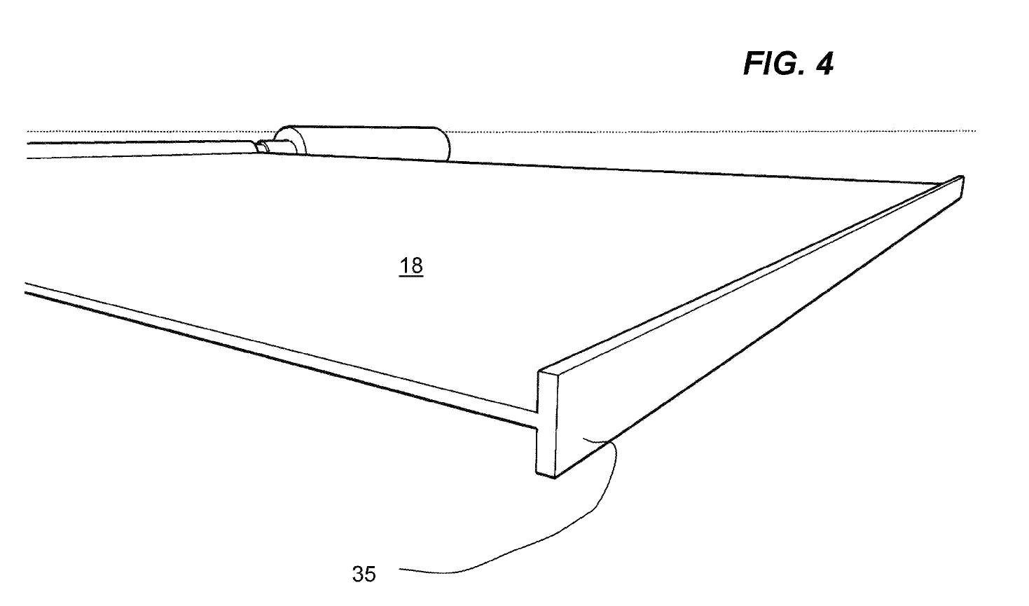

FIG. 5 Perspective view of a hook from a frame.

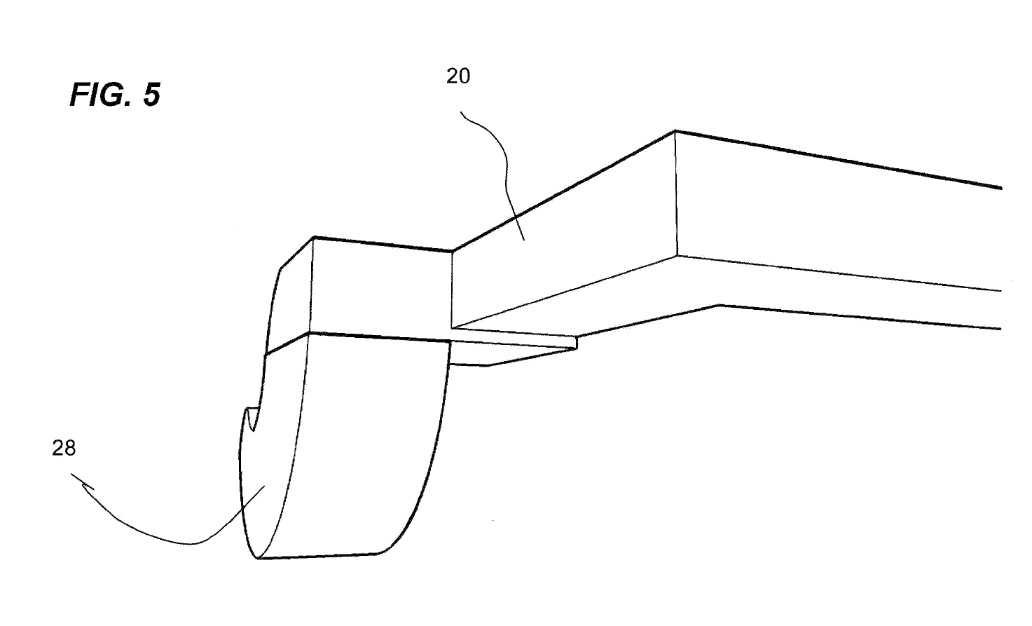

### DETAILED DESCRIPTION OF THE PREFERRED EMBODIMENT

A sushi making apparatus (10) has a board (12), a rolling pin (14), a sushi receptacles (16) which also serves as a cutting guide.

A mat (18) used for forming a sushi strip (not shown). A selection of frames (20) used for measuring quantities. A spatula (22) also used as a variable measuring tool.

The board (12) has a three sided perimeter (24) which has sharp edges (26) so as to neatly cut off and separate excess rice. The fourth side of the perimeter (24) is made with one of the frames (20). the larger the frame (20), the smaller the quantity of rice since the frame (20) is to limit the spread of rice. The frame (20) also has a sharp edge (26) to separate the excess rice. The frame (20) is releasably attached to the board (12) by way of hooks (28) engaging frame notches (30).

The mat (18) has a pair of handles (32) rotating around an axle (31) and at rest, has its handle side resting in a cradle (34) that forms an integral part of one end of the board (12). The opposite end of the mat (18) has a “T” shape (35) which is releasably attached to a slit (36) also forming part of the board (12).

The sushi receptacle (16) is located proximal the slit (36) and is where the sushi (not shown) will end up after having been rolled with the mat (18). The receptacle (16) is releasably attached to the board by way of tenons (38). The receptacle (16) has a plurality of slits so that a knife can cut the sushi into the more familiar bite size portions.

The sushi making apparatus (10) facilitates the making of sushi by combining various operations into a single device. A user puts a quantity of rice onto the mat (18). The rice is spread and flattened within the perimeter (24) using the rolling pin (14). A sheet of algae (15) is placed over the rice. The frame (20) is removed. The rice and algae can be left in place or flipped face down depending on whether the end result is to have the algae on the outside or the inside. The user puts in the various ingredients. Finally, the user takes the handles (32) and rolls the mat (18) until it pushes everything all neatly rolled up into the receptacle (16), ready to be cut.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A sushi making apparatus comprising a board member having first, second, and third side perimeter members forming a three sided perimeter on a top surface thereof, said board member and three sided perimeter formed and adapted to receive and hold a quantity of rice and other sushi ingredients, an elongated cradle portion adjacent an edge of said board member that does not include a side of said three sided perimeter; a mat member adapted to be placed upon said top surface of said board member and in between said three sided perimeter, said mat member including an axle and a pair of handles on opposite ends of said axle, said axle and handles being located on one edge of said mat member and are adapted to be placed within said cradle portion of said board member; at least one frame member adapted and sized to fit upon said top surface of said board member along and adjacent said edge of said board member that includes said cradle member, having a width equal to a distance between the first and third sides of said three sided perimeter, having a predetermined length thereby forming an inner volume in conjunction with the three sides of said three sided perimeter, and having a height equal to the three sides of said three sided perimeter; a rolling pin having a length that is longer than said distance between said first and third sides of said three sided perimeter and adapted to roll along the top edges of said three sided perimeter, and is used to spread and flatten said rice within said square area; and a sushi receptacle placed adjacent the edge of said board member that is adjacent the middle side of said three sided perimeter, said sushi receptacle is adapted to receive said rice and other sushi ingredients when rolled and pushed therein by said mat member.

2. The sushi making apparatus of claim 1, wherein said mat member further includes a T-shaped edge along an edge opposite said edge that includes said axle and handles; and wherein said mat member is formed from a flexible material, and is adapted to roll up said rice and other sushi ingredients into a cylinder shape when said axle and handles are rolled along the length of said first and second perimeter members and toward said sushi receptacle; and wherein

3. The sushi making apparatus of claim 2, wherein said board member further includes a slit along a side thereof adjacent the second perimeter member, said slit being adapted to receive and hold said T-shaped edge of said mat member.

4. The sushi making apparatus of claim 1, wherein said at least one frame member includes at least one hook member adapted to releasably attach to said board member.

5. The sushi making apparatus of claim 4, wherein said board member further includes at least one notch adapted to receive and releasably hold said at least one hook member of said at least one frame member.

6. The sushi making apparatus of claim 1, further comprising a plurality of frame members having differing lengths, wherein one of said plurality of frame members is chosen and used for its desired length, which then correlates to the desired inner volume and amount of rice and other sushi ingredients therein.

7. The sushi making apparatus of claim 1, wherein said sushi receptacle further includes at least one tenon member adapted to releasably attach to said board member.

8. The sushi making apparatus of claim 1, wherein said sushi receptacle includes a plurality of slits therein adapted to receive a cutting instrument therethrough for cutting the rice and other sushi ingredients into a desired number of sections.

9. The sushi making apparatus of claim 1, wherein said three side perimeter members of said three sided perimeter are formed as elongated strips having a sharp top edge along their lengths.

10. The sushi making apparatus of claim 1, further including a spatula member having a length that is longer than said distance between said first and third sides of said three sided perimeter, said spatula being adapted to slide along the top edges of said three sided perimeter and grade off and remove rice and other sushi ingredients that do not fit within said inner volume.

11. A method of making sushi comprising the steps of:
a. placing a mat member over a board member
b. placing a frame member on top of the board member;
c. placing a quantity of rice on top of said mat member and filling the volume defined by said board member and said frame member;
d. spreading and flattening said rice within said volume by using a rolling pin;
e. placing a sheet of algae over said rice;
f. removing said frame;
g. adding other sushi ingredients on top of said rice:
h. rolling said mat member until the rice and other sushi ingredients are firmly and neatly rolled into a sushi roll.

12. A method of making sushi comprising the steps of providing a board member having first, second, and third side perimeter members forming a three sided perimeter on a top surface thereof, said board member and three sided perimeter formed and adapted to receive and hold a quantity of rice and other sushi ingredients, an elongated cradle portion adjacent an edge of said board member that does not include a side of said three sided perimeter; a mat member adapted to be placed upon said top surface of said board member and in between said three sided perimeter, said mat member including an axle and a pair of handles on opposite ends of said axle, said axle and handles being located on one edge of said mat member and are adapted to be placed within said cradle portion of said board member; at least one frame member adapted and sized to fit upon said top surface of said board member along and adjacent said edge of said board member that includes said cradle member, having a width equal to a distance between the first and third sides of said three sided perimeter, having a predetermined length thereby forming an inner volume in conjunction with the three sides of said three sided perimeter, and having a height equal to the three sides of said three sided perimeter; a rolling pin having a length that is longer than said distance between said first and third sides of said three sided perimeter and adapted to roll along the top edges of said three sided perimeter, and is used to spread and flatten said rice within said square area; and a sushi receptacle placed adjacent the edge of said board member that is adjacent the middle side of said three sided perimeter, wherein said frame member is placed on top of said board member; said mat member is placed within the area defined by said frame member; a quantity of rice is placed on top of said mat member filling the volume defined by said board member and said frame member; said rice is spread and flattened within said volume by using said rolling pin; placing a sheet of algae over said rice; removing said frame; rolling said mat member until said rice and other sushi ingredients are firmly and neatly rolled into said sushi receptacle as one long sushi roll; cutting said sushi roll into a desired number of smaller sushi rolls.
